(19) United States
(12) Patent Application Publication
(10) Pub. No.: US 2023/0028506 A1
(43) Pub. Date: Jan. 26, 2023

(54) Method for Processing Plants in a Field

(71) Applicant: Robert Bosch GmbH, Stuttgart (DE)

(72) Inventors: Markus Hoeferlin, Simmozheim (DE); Maurice Gohlke, Stuttgart (DE); Sandra Amend, Maintal (DE); Daniel Di Marco, Stuttgart (DE)

(21) Appl. No.: 17/756,158

(22) PCT Filed: Nov. 20, 2020
(86) PCT No.: PCT/EP2020/082844

§ 371 Date: May 18, 2022

(30) Foreign Application Priority Data
Nov. 25, 2019 (DE) 10 2019 218 188.0

(51) Int. Cl. A01B 39/18; A01B 79/00; G06V 10/44; G06V 10/82; G06V 20/56; G06V 20/68

(52) U.S. Cl. CPC A01B 39/18; A01B 79/005; G06V 10/454; G06V 10/82; G06V 20/56; G06V 20/68

(57) ABSTRACT

The disclosure relates to a method for processing plants in a field in which a specific type of crop is planted, said method having the following steps: selecting a processing tool for processing plants; acquiring an image of the field, the image being correlated with position information; determining a position of a plant to be processed in the field using a neural network into which the acquired image is input, the neural network having a plurality of heads and in particular one of the heads being evaluated according to the processing tool and/or the type of crop grown; guiding the processing tool to the position of the plants; and processing the plants using the processing tool.

### TECHNICAL FIELD

The present invention relates to a method for processing plants in a field.

Among the diverse tasks in agriculture, weed control is of central importance for success in terms of yield. The costs for pesticides are considerable and the effects thereof on the environment are problematic. Therefore, use is increasingly being made of autonomously working systems for processing plants, i.e. useful plants and weeds. In this case, the processing can be effected mechanically, e.g. By a rotary tiller, but also by targeted application of pesticides, e.g. by a controlled sprayer. In this way the use of pesticides can be avoided or at least reduced, as a result of which the influence on the environment and also the expenditure in terms of costs are reduced.

For selective (the plant to be processed is distinguished from other plants and the soil) plant processing in a field, it is necessary for the position of a plant to be processed in a field to be recognized exactly. This can be accomplished by various object recognition methods, optical image recognition by means of a trained classifier, e.g. a neural network, primarily being used.

In this case, a semantic segmentation of a captured image, but also a classification of the image or of an image section can be carried out.

In practice, use is made of vehicles or apparatuses for processing plants for various processing tools and in fields in which various useful plants are grown, a classifier specifically provided therefor, having to be used in each case. However, this results in the following disadvantages: a plurality of classifiers lead to an increased memory requirement. Moreover, in the case of trained classifiers, a large amount of specific training data is required for the individual classifiers and an increased processing time is necessary in order to train or implement the individual classifiers.

Therefore, it is an object of the present invention to avoid these disadvantages mentioned and to provide a method for processing plants in a field which is usable in a flexible way for various objectives for processing plants in a field.

### BRIEF DESCRIPTION OF THE FIGURES

FIG. 1 shows a flow diagram of the method according to the invention;

FIG. 2 shows a set-up of a neural network having a plurality of heads trained for a different type of useful plant;

FIG. 3 shows a set-up of a neural network having a plurality of heads trained for a different hierarchical level;

FIG. 4 shows a set-up of a neural network having a plurality of heads trained both for a different type of useful plant and for a different hierarchical level;

FIG. 5 shows a set-up of a neural network having a plurality of heads which branch off in a different layer of the neural network.

### DESCRIPTION OF THE EMBODIMENTS

Embodiments of the present invention are described below with reference to the accompanying figures.

A vehicle to which an apparatus for processing plants is attached traverses a field along a route and the objects or plants to be processed are individually processed successively by the method 100 according to the invention being carried out. In this case, the vehicle traverses the field autonomously, but can also traverse the field in accordance with control by an operator.

A field can be understood to mean a delimited area of land for growing useful plants or else a portion of such a field, A useful plant is understood to mean an agriculturally used plant which is used itself or the fruit of which is used, e.g. as foodstuff, feedstuff or as energy crop. The seeds and thus the plants are primarily arranged in rows, in which case objects may be present between the rows and also between the individual plants within a row. The objects are undesired, however, since they reduce the yield of the plants or constitute a disturbing influence during cultivation and/or harvest. An object can be understood to mean any plant that is different than the useful plant, or any article. Objects may be, in particular, weeds, pieces of wood and stones.

For this purpose, the apparatus for processing plants has at least the following elements: a processing tool, an image capturing means, various sensor elements (e.g. a position sensor, a speed sensor, an inclination sensor, a distance sensor etc.), a storage unit and a computing unit.

The apparatus for processing plants is installed on a vehicle provided therefor, which vehicle is operated by a battery that can also be operated by some other energy source, such as an internal combustion engine, for instance. Furthermore, the apparatus can also be attached to an agricultural vehicle or a trailer for the agricultural vehicle. In this case, the apparatus is operated by an energy source of the vehicle but can also be operated by a separate energy source provided therefor.

The processing tool is a mechanical tool which is attached to a movable apparatus, such that it can be guided toward or away from a plant to be processed, and is configured such that a plant is processed thereby. The movable apparatus is for example an arm with joints which is moved by electric motors or a hydraulic system. The processing tool is e.g. a rotary tiller that severs the plant, i.e. a weed in this case, in the region of the roots. However, the processing tool can also be a sprayer that sprays a pesticide in the direction of a plant to be processed. It should be noted that the sprayer can also be used for applying a crop protection agent or fertilizer to a useful plant. Furthermore, even further processing tools, such as, for instance, an electric processing tool, a laser, microwaves, hot water or oil, are conceivable. In this case, the processing tool installed on the vehicle has a specific spatial accuracy. The spatial accuracy in the case of a rotary tiller is dependent on the movable apparatus and the mechanical configuration (e.g. the diameter) of the rotary tiller itself. The spatial accuracy in the case of a sprayer is dependent on a nozzle angle of the sprayer. In this case, the spatial accuracy in the case of a sprayer is lower than that in the case of a rotary tiller by a multiple. Furthermore, it is also possible for a plurality of processing tools to be attached to an apparatus for processing plants, which processing tools can be operated simultaneously. It is also possible for different types of processing tool to be attached to the same apparatus for processing plants. The processing methods conceivable here are: electrically, by means of a laser, by means of microwaves, and by means of hot water or oil.

The image capturing means is a camera, such as e.g. a COD camera, a CMOS camera, etc., which captures an image in the visible range and provides it as RGB values or as values in some other color space. However, the image capturing means can also be a camera that captures an image in the infrared range. An image in the infrared range is particularly suitable for capturing plants since a reflection of the plants is significantly increased in this frequency range. However, the image capturing means can also be e.g. a mono, RGB, multispectral, hyperspectral camera. The image capturing means can also provide a depth measurement, e.g. by means of a stereo camera, a time-of-flight camera, etc. It is possible for a plurality of image capturing means to be present, and for the images to be captured by the different image capturing means and also the data to be acquired by the various sensor elements substantially synchronously.

The operation of the apparatus for processing plants requires further data, which are acquired using various sensor elements. In this case, the sensor elements can comprise a position sensor, e.g. GPS, high-accuracy GPS, etc., a speed sensor, an inclination sensor, a distance sensor, but also other sensors, such as, for instance, a weather sensor, etc.

The storage unit is a non-volatile physical storage medium, such as a semiconductor memory, for example, in which data can be stored for a relatively long time. The data remain stored in the storage unit even when no operating voltage is present at the storage unit. The storage unit stores a program for carrying out the method according to the invention and operating data required therefor. Moreover, the images captured by the image capturing means and the data acquired by the sensor elements are stored on the storage unit. However, other data and information can also be stored in the storage unit.

The program stored in the storage unit contains instructions in the form of program code written in an arbitrary programming language, said instructions being executed in sequence so that the method 100 according to the invention for processing the plants in the field is carried out. In this case, the program can also be divided into a plurality of files having a predefined relation to one another.

The computing unit is an arithmetic logic unit that is implemented in the form of a processor (e.g. CPU, GPU, TPU). The computing unit is able to read data from the storage unit and to output instructions according to the program in order to control the image capturing means, the sensor elements and actuators, such as the processing tool, for instance, which are all connected to the computing unit communicatively (in a wired or wireless manner).

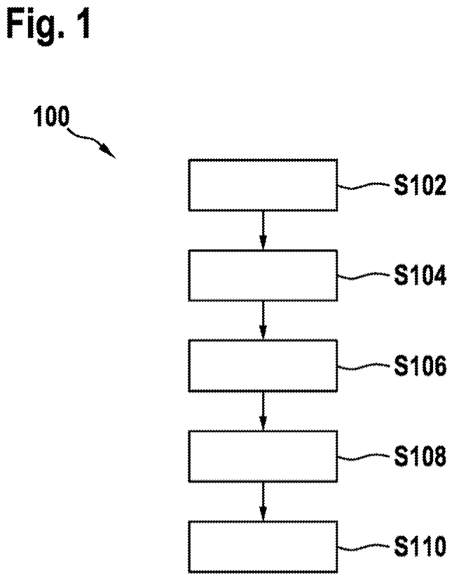

During a traversal, the individual method steps S102 to S110 of the method 100 according to the invention, as shown in FIG. 1, are carried out in sequence. The individual steps are described in detail below:

Initially, in step S102, the processing tool is selected which is intended to process the plants or objects in a field. In this case, as described above, the spatial accuracy with which the plants are processed by the processing tool is dependent on the type of processing tool. The processing tool can be defined for the entire duration of the traversal before the traversal of the field starts. However, the processing tool can also be changed during a traversal.

Afterward, in step S104, an image 12 of the field in which the plants are growing is captured by the image capturing means. The image capturing means is attached to the vehicle in such a way that an image sensor is substantially parallel to a surface of the ground of the field. Moreover, position information about the position at which the image 12 is captured in the field is obtained substantially synchronously with the capturing of the image 12. The position information obtained by the position sensor is correlated with the image 12, such that actual positions of pixels of the image 12 in the field can be determined taking account of the position information, the image angle of the image capturing means used and the distance between the image capturing means and the ground. However, the image capturing means can also be attached in such a way that the image sensor is inclined in an arbitrary direction in order to capture a larger region of the field. In this case, the inclination angle is to be taken into account when determining the position of a pixel in the field.

In the subsequent step 106, the captured image 12 is processed in order to determine a position of the plants to be processed in the field. In this case, the positions of the plants to be processed are determined individually by information about the represented content being allocated to the pixels of the captured image 12. Since the position of the individual pixels in the field is known, the respective positions of the plants to be processed can be determined. In this case, the position of a plant in a field is preferably determined by means of a semantic segmentation of the captured image 12 correlated with the position information. The semantic segmentation, in which each pixel of an image 12 is classified individually, is obtained by employing a so-called fully convolutional DenseNet. However, a semantic segmentation can also be obtained by a fully convolutional neural network or some other suitable neural network. Methods for the pixel-by-pixel semantic segmentation of images are known in the prior art from the following documents: Long, J., Shelhamer, E., & Darrell, T. (2015), “Fully convolutional networks for semantic segmentation”. In Proceedings of the IEEE conference on computer vision and pattern recognition (pages 3431-3440), Jégou, S., Drozdzal, K., Vazquez, D., Romero, A., & Bengio, Y. (2017), “The one hundred layers tiramisu: Fully convolutional densenets for semantic segmentation”, In proceedings of the IEEE Conference on Computer Vision. and Pattern Recognition Workshops (pages 11-19). Furthermore, it should be noted that regions, so-called superpixels, in the image 12 can also be semantically segmented. Furthermore, the position of the plants to be processed can be determined by means of a classification of the image 12 or some other known method for object recognition in which a neural network is used. Hereinafter, both the semantic segmentation of the pixels or super pixels, i.e. the pixel-by-pixel classification, and the (standard) classification of the image are referred to as classification, for simplification.

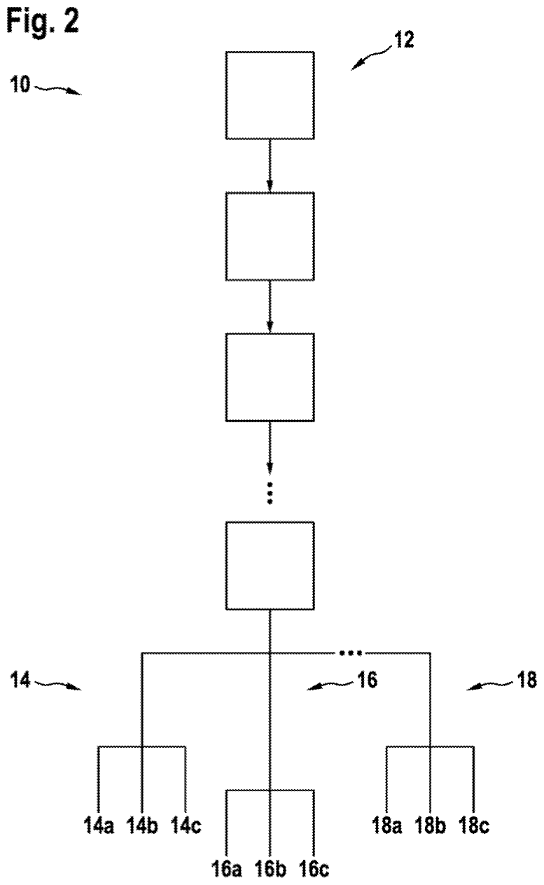

A respective position of the plants to be processed in the field is determined, as already mentioned, using neural networks 10, 20, 30, 40, which are shown in FIGS. 2 to 5 and into which the image 12 (the RGB values or the values of some other color space) captured in S104 is input in this case, neural networks 10, 20, 30, 40 according to the invention are configured as so-called tree networks or treenets and have a plurality of heads, wherein only one of the heads is evaluated according to the selected processing tool and/or the types of useful plant grown in the field.

The neural networks 10, 20, 30, 40 shown have in each case a plurality of heads 14, 16, 18, 24, 26, 28, 14′ and 16′ for outputting classification results 14a to 14c, 16a to 16c, 18a to 18c, 24a to 24c, 26a to 26c, 28a to 28c, 14a′ to 14c′ and 16a′ to 16c′. Tree networks that likewise have a plurality of heads are known in the prior art, said plurality of heads being provided for achieving the same objective. Afterward, in the case of the neural networks known in the prior art, the results of the individual heads are evaluated as a so-called ensemble in order to be able to determine a fluctuation or variation of the results of the individual heads. For this reason, the heads branch off in a layer further toward the top of the neural network, such that the jointly used part of the neural network is small, thereby ensuring that the classification results of the individual heads do not have an excessively large and unwanted correspondence.

When a classification is carried out by the neural networks 10, 20, 30, 40 according to the invention, in particular only one of the heads 14, 16, 18, 24, 26, 28, 14′ and 16′ is evaluated and the other heads are disregarded. In the case of the neural networks 10, 20, shown in FIGS. 2 to 4, the individual heads 14, 16, 18, 24, 26, 28 are even split off only in the last layer, such that almost the entirety of the neural networks 10, 20, 30 are used for the classification by the individual heads 14, 16, 18, 24, 26 and 28. Compared with the typical ensemble tree networks, the heads 14, 16, 18, 24, 26 and 28 can therefore be split off in a lower section of the neural networks 10, 20, 30 since there is no need to train different features between the heads 14, 16, 18, 24, 26 and 28 in this case. Consequently, in the case of the present invention, a large portion of the neural networks 10, 20, 30 can be used for different objectives.

In the case of the neural networks 10, 20, 30, 40 mentioned, jointly used layers arranged in an upper section are trained with the same training data. In this case, the upper layers are trained in such a way that the neural networks 10, 20, 30, 40 for one head (e.g. head 14) are trained completely over all layers. This procedure has the advantage that the neural networks 10, 20, 30, 40 can be initially trained with a sufficiently large amount of training data, thus ensuring a required accuracy of the individual layers of the neural network 10, 20, 30, 40 when generating feature spaces from the image that is input. Afterward, the trained head is copied as necessary. The training can also be effected in parallel for the required number of heads.

Afterward, the individual heads 14, 16, 18, 24, 26, 28, 14′ and 16′ of the neural networks 10, 20, 30, 40 are specifically trained with training data provided therefor. This procedure for training a neural network is also referred to as fine tuning. Fine tuning is thus understood to mean the subsequent training of an already existing neural network or of a part thereof (e.g. the section of the head after branching off) with new training data and/or other training parameters in order to achieve some other stipulated objective. If only a section of a neural network is subsequently trained, this head can also be trained with other training data for the same stipulated objective, whereby a deviating classification result is obtained.

The neural networks 10, 20, 30, 40, as described above, are initially trained with a data set (e.g. for maize) having a sufficient amount of data in order to train the jointly used layers in an upper region of the neural networks 10, 20, 30, 40. In this case, these layers extract from the essential features necessary for the classifications Afterward, the lower layers in the individual heads 14, 16, 18, 24, 26, 28, 14′ and 16′ (sometimes even only the last layer for outputting the classification result 14a to 14c, 16a to 16c, 18a to 18c, 24a to 24c, 26a to 26d, 28a to 28c, 14a′ to 14c′ and 16a′ to 16c′) are trained with a (usually very much) smaller amount of specific training data in order to train the heads 14, 16, 18, 24, 26, 28, 14′ and 16′ of the neural networks 10, 20, 30, 40 for a specific classification problem. The advantage of fine tuning is that a large portion of the neural networks 10, 20, 30, 40 can be trained with a large amount of training data, while the individual, heads 14, 16, 18, 24, 26, 28, 14′ and 16′ are optimized using a smaller specific training data set. Consequently, a large amount of training data is not required for all the heads 14, 16, 18, 24, 26, 28, 14′ and 16′ of the neural networks 10, 20, 30, 40.

In a first configuration of the present invention, as shown in FIG. 2, the individual heads 14, 16, 18 of the neural network 10 according to the invention are trained in such a way that a different type of useful plant, grown in different fields to be processed, can be recognized using their classification results 14a to 14c, 16a to 16c, 18a to 18c. The heads can then distinguish between a useful plant 14a, 16a, 18a (e.g. maize, sugar beet, etc.), weeds 14b, 16b, 18b and the soil 14c, 16c, 18c. In this case, as already described, the individual heads 14, 16, 18 of the neural network 10 can be specifically trained by means of fine tuning.

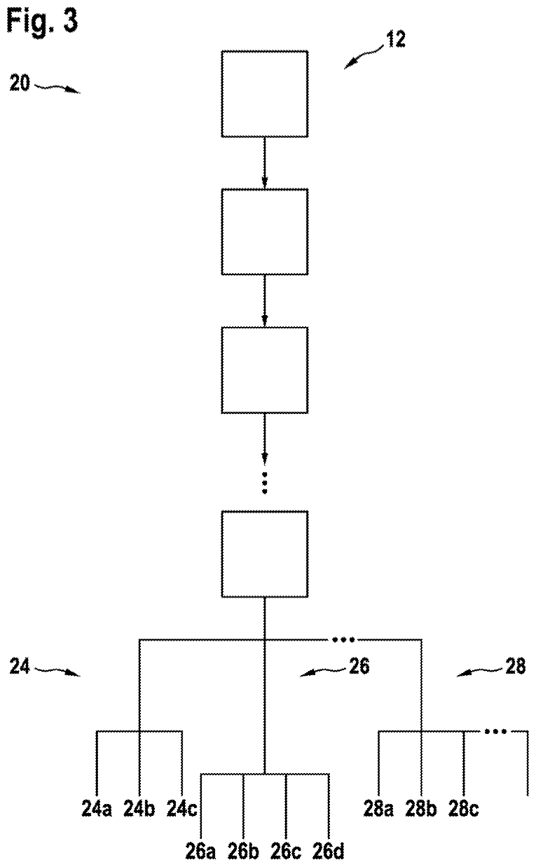

In a second configuration of the present invention, the individual heads 24, 26, 28 of the neural network 20 according to the invention, as shown in FIG. 3, are trained for different hierarchical levels. In this case, e.g. one head 24 is trained only for a differentiation between a useful plant 24a (e.g. maize or sugar beet), weeds 24b and soil 24c. Further heads 26, 28 can be trained, moreover, which enable a differentiation between a useful plant 26a, dicotyledonous weeds 26b, monocotyledonous weeds 26c and the soil 26d or generally a type-specific differentiation between plant A 28a, plant. B 28b, plat C 28c, etc. It should be noted here that the classification for a higher hierarchical level comprising a more general grouping of plants (e.g. weeds) is more robust and more accurate than a classification for a lower hierarchical level (e.g. plant A vs. plant B etc.)

In addition, herbicides applied to the field in order to remove weeds are often effective for whole plant groupings. In this regard, for example, herbicides are available which are effective for dicotyledonous weeds or monocotyledonous weeds. The second configuration of the invention can thus be used for targeted application of an herbicide to a corresponding plant grouping since a classification for a hierarchical level is flexibly adaptable. In this way, the amount of herbicide to be applied to the field can be reduced.

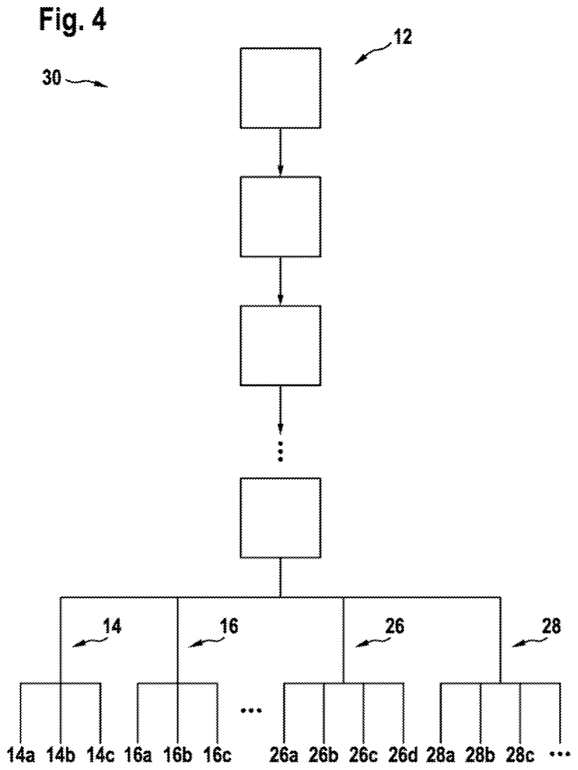

Furthermore, it is also possible to combine the first and second configurations shown in FIG. 2 and in FIG. 3, such that the different heads of a neural network in accordance with a third configuration, as shown in FIG. 4, are trained both for different useful plants and different hierarchical levels. Using the neural network 30, for example, it is then possible to recognize different types of useful plants (e.g. maize, sugar beet, etc.) by means of the heads 14 and/or 16 and different hierarchies (e.g. dicotyledonous and monocotyledonous plants) by means of the heads 26 and 28. It is self-explanatory here that the same hierarchical level can also be present repeatedly for the different useful plants.

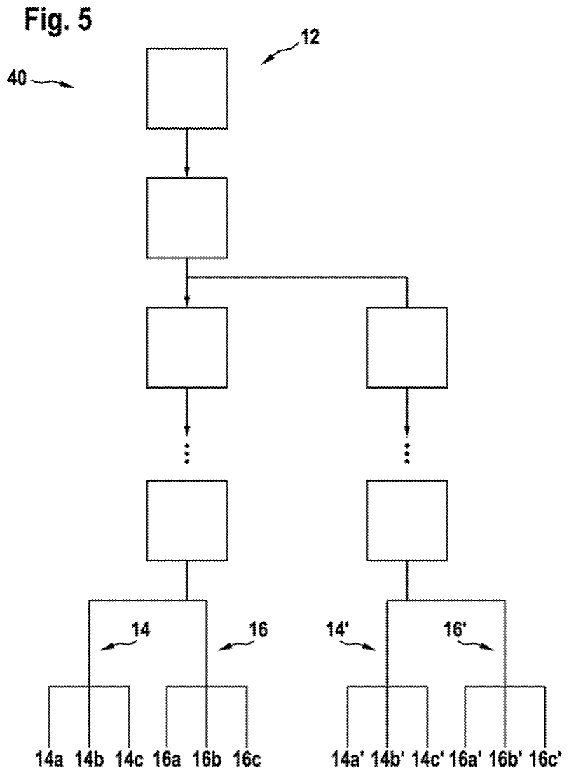

In addition, the neural network 40 according to the invention is not restricted to the heads branching off in the same layer of the network. In accordance with a fourth configuration, the individual heads 14, 16, 14′ and 16′, as shown in FIG. 5, can branch off in a different layer of the neural network 40. In addition, further layers can be present between the branching off and the output layer of a head. The neural network 40 can be set up flexibly in this way.

On account of the flexible set—up of the neural network 40, it is also possible for two or more heads 14 and 14′ and/or 16 and 16′ of the neural network 40 to be trained in different ways for the same objective. The classification results 14a to 14c and 14a′ to 14c′ and/or 16a to 16c and 16a′ to 16c′ of the two or more heads 14 and 14′ and/or 16 and 16′ can subsequently be evaluated as an ensemble. Consequently, the present invention can be combined with the original concept of the tree networks for ensemble evaluation, such that an ensemble of classification results is available for each useful plant. It should be noted that it is likewise possible for only one of the heads 14, 14′, 16, 16′ to be evaluated in the case of the neural network 40. It is therefore not absolutely necessary to carry out an ensemble evaluation.

After the position of the plants to be processed in the field has been determined in step S106 using the neural network 10, 20, 30, 40 according to the invention, in step S108 the selected processing tool can be guided to the position of the plant and the corresponding processing can be carried out for the individual plant. In this case, a mechanical tool can be accurately guided right up to the position of the plant or the sprayer, for applying the pesticide, crop protection agent or fertilizer, can be guided to a position at a predefined distance from the weed or the useful plant and can be directed at the latter. In order to enable an exact control of the movable apparatus, it may be necessary here for the position of the plant ascertained by means of the image to be converted into the coordinate system of the movable apparatus. A speed at which the vehicle moves forward should additionally be taken into account when guiding the processing tool.

Afterward, in step S110, the plant is processed by the processing tool. In this case, by means of the use of the mechanical tool, the plant is removed, chopped or destroyed or sprayed with the pesticide, crop protection agent or fertilizer. As a result of the mechanical processing of the plants or the targeted application of chemical substances, the amount of chemical substances applied in conventional methods can thus be significantly reduced, with the result that costs and the influence on the environment are reduced.

The present invention provides the following advantages in this case.

Instead of a plurality of independent neural networks, a single neural network having a plurality of heads can be used, with the result that a necessary memory requirement is reduced.

As a result of the joint training of the layers in the upper region of the neural network, a better trained neural network is obtained which provides a better differentiation between the plants because more training data of different useful plants and/or hierarchical levels are used. The neural network is thus trained to the effect that it finds features for all useful plants simultaneously. Since training data are used jointly in the upper region of the neural network, fewer resources are required for training the network.

The neural network according to the invention can be subsequently trained in a simple manner since improved features that are formed on the basis of subsequent training are immediately available for all heads of the neural network. When a plurality of neural networks are used, however, it is necessary to that effect to update the different neural networks with the subsequently trained parameters.

In addition, at the beginning of the processing (i.e. when the apparatus for processing plants in the field is started), only one neural network has to be loaded. A change between different useful plants and/or hierarchical levels is thus possible in a flexible way without new loading of some other neural network, since the change is able to be carried out in a simple manner by way of the evaluation of a different head.

The envisaged area of use of the method according to the invention relates to autonomous field robots or intelligent mounted implements for tillage and plant protection in the growing of vegetables, horticulture and arable farming. In principle, the neural networks described above can also be used in other areas in which a neural network is intended to be usable in a flexible way for various objectives.

1. A method for processing plants in a field in which a specific type of useful plant is grown, using a processing tool, the method comprising:
capturing an image of the field, the image being correlated with position information;
determining a position of a plant to be processed in the field using a neural network, into which the captured image is input, the neural network having a plurality of heads one head of the plurality of heads being evaluated according to at least one of the processing tool and the specific type of useful plant that is grown;
guiding the processing tool to the position of the plant; and
processing the plant using the processing tool.

2. The method as claimed in claim 1, wherein jointly used layers of the neural network are trained with same training data.

3. The method as claimed in claim 1, wherein individual heads in the plurality of heads of the neural network are trained with specific training data.

4. The method as claimed in claim 3, wherein individual heads in the plurality of heads of the neural network are trained for different types of useful plant.

5. The method as claimed in claim 3, wherein individual heads in the plurality of heads of the neural network are trained for different hierarchical levels.

6. The method as claimed in claim 3, wherein individual heads in the plurality of heads of the neural network are trained both for different types of useful plant and for different hierarchical levels.

7. The method as claimed in claim 1, wherein individual heads in the plurality of heads of the neural network branch off at a different level of the neural network.

8. The method as claimed in claim 1, wherein:
at least two heads in the plurality of heads of the neural network are trained in different ways to carry out a same classification; and
classification results of the at least two heads are evaluated as an ensemble.

9. A controller for controlling a processing tool for processing plants in a field in which a specific type of useful plant is grown, the controller being configured:
receive a captured image of the field, the image being is correlated with position information;
determine a position of a plant to be processed in the field using a neural network, into which the captured image is input, the neural network having a plurality of heads, one head of the plurality of heads being evaluated is evaluated according to at least one of the processing tool and the specific type of useful plant that is grown; and
output a control signal configured to control the processing tool so as to process the plant.

10. An agricultural work machine comprising:
a processing tool configured to process plants in a field in which a specific type of useful plant is grown; and
a controller configured to:
receive a captured image of the field, the image being correlated with position information;
determine a position of a plant to be processed in the field using a neural network, into which the captured image is input, the neural network having a plurality of heads, one head of the plurality of heads being evaluated according to at least one of (i) the processing tool and (ii) the specific type of useful plant that is grown; and
output a control signal configured to control the processing tool so as to process the plant.
